(19) United States
(12) Patent Application Publication
(10) Pub. No.: US 2008/0047969 A1
(43) Pub. Date: Feb. 28, 2008

(54) METHOD FOR DETECTING PILL REMOVALS FROM PRE-SORTED MEDICINE ARRAY PACKS

(76) Inventors: Fariborz M. FARHAN, Alphretta, GA (US); John W. Peifer, Atlanta, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/843,633

(22) Filed: Aug. 22, 2007

Related U.S. Application Data
(60) Provisional application No. 60/823,230, filed on Aug. 22, 2006.

(51) Int. Cl. G07F 11/00; G07F 13/00; G07F 9/02

(52) U.S. Cl. 221/7; 221/1; 221/3

(57) ABSTRACT

The invention consists of a medication docking station that will accept pre-sorted medication array packages (a.k.a “blister packs”). The docking station will use digital image processing schemes to determine the state of each medication chamber. The digital image processing algorithm uses color content of a given cell (chamber) as a means to determine the state of that cell. If the color content matches that of a known empty cell, then the cell will be reported as empty, otherwise it will be determined as non-empty. The method can detect partial removal of medication pills. Also the information regarding the med-pack can be transmitted via wired or wireless means to a custom server or personal computer for further processing or forwarding to a user-client on the internet interested in adherence of a patient or care-recipient in taking medication.

### CROSS-REFERENCE TO RELATED APPLICATIONS

This application is related to and claims the benefit of Provisional U.S. patent application No. 60/823,230 filed by Farhan on Aug. 22, 2006 and incorporated herein by reference.

### BACKGROUND OF THE INVENTION

Medication adherence errors are a major health problem in the United States, and they become particularly complicated as people age into disability. The need for better medication management extends to the large percentage of people over age 60, who take one or more medications on a daily basis. Among this aging population, there are frequent problems with misuse of medicine. The present invention attempts to provide a method for error-free medication management

The current state of the art includes several methods of dispensing pills and medication that require a person to fill up the medication dispenser. Invariably, in all these cases an error that may occur during the filling of the dispenser may not be detected. Some of the techniques that have been presented to address this issues include U.S. Pat. Nos. 5,408,443 by Weinberger, 5,200,891 by Kehr et al., 5,289,157 by Rudick et al., 4,838,453 by Luckstead, 4,573,606 by Lewis et al., 4,971,221 by Urquhart et al., 6,169,707 by Newland, 5,159,581 by Agans, 5,710,551 by Ridgeway, 5,805,051 by Herrmann et al., 6,364,517 by Yuyama et al., 6,771,174 by Broas, 6,961,285 by Niemiec et al., 7,002,476 by Rapchak, 6,048,087 by Laurent et al., 5,954,225 by Powe, 6,401,991 by Eannone, 6,625,518 by Depeursinge, 6,145,697 by Gudish, 5,646,912 by Cousin, 6,138,865 by Gilmore, 6,131,765 by Barry et al., 5,850,937 by Rauche, 6,662,081 by Jacober, and US Patent Applications 2002/0149473 by Romano et al., 2005/0187789 by Hatlestad et al. and 2002/0165641 by Manalang et al.

Hanpeter et al. in U.S. Pat. No. 4,616,316 teaches a medication compliance system using special medication blister package with conductive traces upon a frangible backing of medication compartment. Hanpeter thus requires a special blister packaging and rendering it not generally available to public.

Parkhurst et al. in U.S. Pat. No. 5,412,372 teaches a portable medication dispenser that uses standard blister packages for dispensing medication. Parkhurst therefore does not require a human person to fill up the dispenser as the blister packages have already been filled up by a professional pharmacy or pharmaceutical company. Parkhurst discusses, at a high level, several methods for detecting removal of pills from a blister compartment including an optical method using optical fibers and an electrical method. Parkhurst fails to provide details on the source of optical energy and the detection mechanism. Parkhurst also assumes that each blister is representative of one type of medication therefore for a patient that has several types of blister packs, several dispensers will be required. Also Parkhurst does not talk about the case of detecting partial removals.

### BRIEF SUMMARY OF THE INVENTION

The present invention takes advantage of the latest advances in medication packaging to offer a very reliable medication dispensing and adherence tracking method and system. Most of the related art has been focused on pill dispenser solutions. The issue with these solutions is that as long as humans are filling up the dispenser there will be chance of error. With the advancements in medication packaging, commercially and generally available these days, the worry and responsibility of creating the proper combination of medication and pills for a given dose are carried by a professional pharmacy or a pharmaceutical agency. These packages combine one or several pills or capsules into one blister compartment to create the proper dose for a certain time of the day. These pre-sorted medication blister array packages typically provide a week's consumption of medication and come in four rows and 7 columns. The rows represent the time of the day: morning, noon, afternoon and night and the columns represent the days of the week. Alternatively, some packaging systems, such as the one illustrated in FIG. 2, organize medications into four separate color coded blister cards for morning, noon, evening, and night medications. This monthly organizer uses five rows of seven pill compartments to hold enough medicine for any month.

The current invention takes advantages of this advanced packaging solution and complements it by providing a reliable method for monitoring adherence and proper usage. The present invention provides an active storage facility for the 4×7 or 5×7 monthly organizer blister packs, as well as other configurations. When it is time for a dosage to be taken the device will provide a visual and audible indication for the user to take his or her medication. If the blister pack is not removed and returned after a reasonable wait time a visual and audible alarm will sound which if ignored will report the condition to a local gateway device or optionally directly to another computer through a wired or wireless method across the public network.

When the blister pack is returned to the device, a digital scanner inside the unit will scan the blister pack and begin digitally processing the image obtained. The digital image processing algorithm will examine the contents of all the medication compartments. The algorithm measures the color content of each bin and compare that to that of a blank (or black) bin. This method can detect partial removals and report the condition locally or transmit to a gateway or across a network.

Adherence to medication plans is important for elders to maintain health and independence, but medication mistakes may often occur because the prescription schedules are demanding, confusing, and unpleasant. The medication monitoring device enables remote caregivers to customize adherence strategies to meet their individual needs. The device will complement electronic medication lists and systems for remote medication reminders. This monitoring device will be able to provide a higher level of assurance to the remote caregiver that the elder is adhering to the medication schedule.

### BRIEF DESCRIPTION OF SEVERAL VIEWS OF THE DRAWINGS

FIG. 1: is a perspective view of the medication monitoring management device according to the present invention

FIG. 2 is an illustration of a commercially available pre-sorted medication array packages

FIG. 3 is an illustration of an insertion or removal of a pre-sorted medication package into or out of the present invention

FIG. 4 is a system view of the present invention

FIG. 5 is an illustration of a real-life use scenario of the present invention

FIG. 6 is a detailed illustration of the insertion of the pre-sort medication array package into the present invention

### DETAILED DESCRIPTION OF THE INVENTION

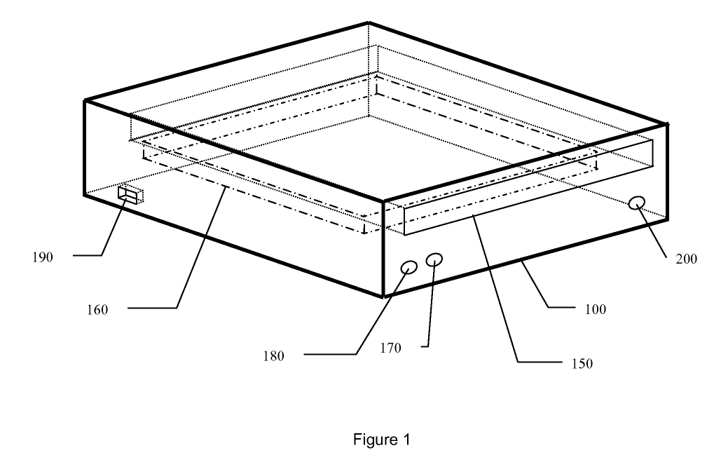

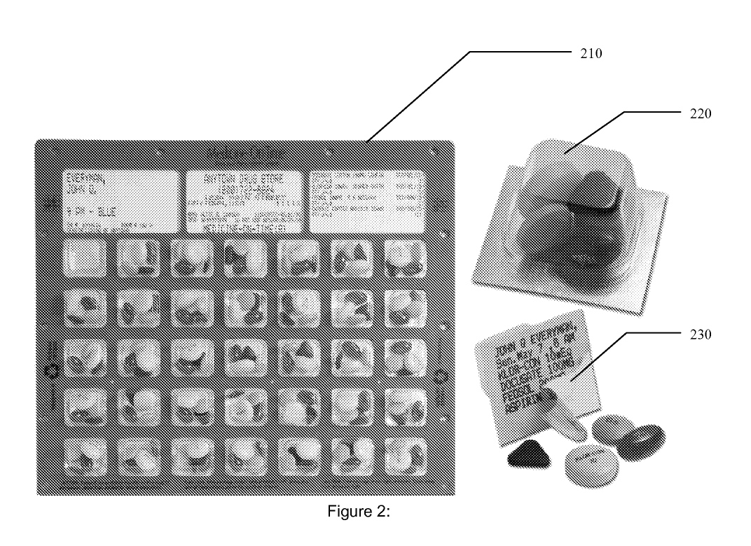

The improved medication monitoring device of the present invention is shown in FIG. 1. A preferred embodiment of the present invention permits monitored dispensing of pre-sorted medication array packages of FIG. 2. The medication monitoring device of the present invention is typically a box 100, with an opening 150 to allow the insertion or removal of the medication package. An optical digital scanner 160 using available technology is embedded inside the unit. When the medication package is inserted into the cavity, a child-proof locking mechanism locks the package inside the unit and the optical scanner 160 begins optically scanning the transparent of the medication package. A preferred embodiment of the present invention includes a communication port 190 for wired communication as well as a wireless communication port 200, a visual alarm indicator 170 and a visual power-on indicator 180

Several companies are now addressing the difficulty and errors of manually loading pill organizers by providing individualized packaging services through professional pharmacies, such as the personal prescription system shown in FIG. 2. What is shown in 210 is a commercially available pre-sorted medication package with 5×7 bins that is capable of holding an entire months supply for any daily medicine period. For people who take medicines more than one time a day, this company uses additional color coded blister packs to hold the medicines for the different times during the day (for example morning, noon, evening, and night). Each personal blister packages is packed with medication for individuals who live independently, in assisted living centers, or in nursing homes. The individual pill compartments 220 are composed of a transparent plastic that makes it easy to visually observe the compartment's contents. As illustrated in FIG. 2, each pill compartment 230 in the packaging is labeled with the individual's name, the medications contained in the compartment, and the date and time to be taken. This product overcomes the limitations of simple pill organizers that must be filled by hand. In the invention, this prepackaged medication card will be inserted into a monitoring device that sends information to remote caregivers about which compartments have been opened.

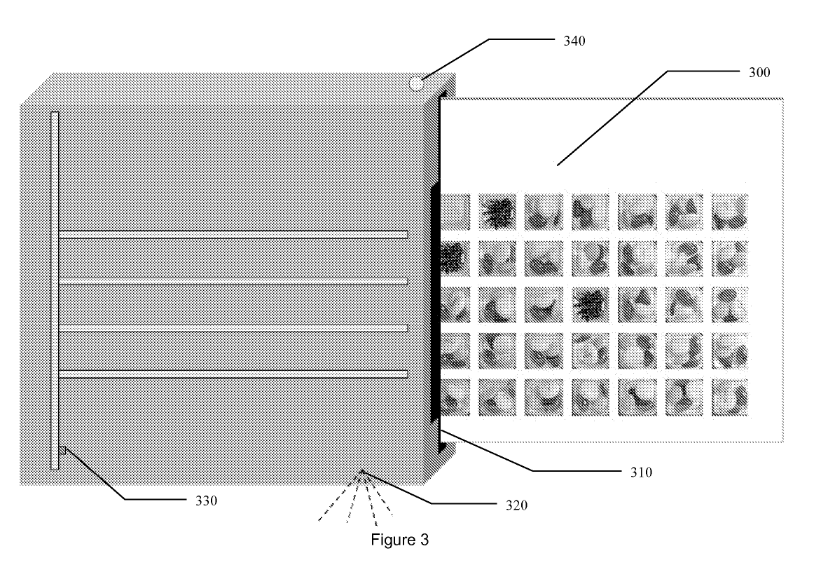

FIG. 3 is an illustration of how the medication package of FIG. 2, 300, can be insertion into present invention. The enclosure 100 is designed to be just large enough to surround the prepackaged medication card. This form factor will fit easily into a wide variety of home environments and medication adherence strategies. The medication monitoring device is designed to work with prepackaged medication cards to greatly reduce the complexity and potential errors from family members manually loading pill organizers or dispensers.

Different size versions of the invention will accommodate all blister pack sizes and compartment arrangements. The same technical approach, networking infrastructure, and caregiver interface can be used for other packaging configurations with only minor changes to the docking station.

The monitoring device serves as a docking station to store the prepackaged medications between uses, and it can be moved from room to room to integrate medication management more easily and comfortably into daily activities.

While small size and mobility could lead to the elder misplacing the device, this would be detected by the remote caregiver because scheduled medications would not get removed from the package. Another potential risk that goes along with mobility is that children living in or visiting the home could discover the medicine storage device. While families should continue with all the safeguards that they currently employ to keep medicine away from children, there are several additional security measures that the proposed system can offer. The medications in the blister packs will no longer be visible (tempting to a child) and no pill compartments can be opened when the package is docked in the station. One implementation of the invention will include a mechanical locking device to prevent access without a key to the medication package when it is stored in the docking station. Another implementation of the inventions will use an electronic locking mechanism to prevent access without entering a pass code. The electronic locking system can also be activated by the remote caregiver.

An advantage of the current invention over alternative approaches is that it is designed to be a component of a larger wellness monitoring and communications system connecting remote family caregivers. By using an external base station to communicate with the caregiver, the medication monitoring device can be simpler, smaller, and less expensive than other medication monitoring products. In this approach, communication between the elder and their informal caregivers also will help to reduce medication errors. It has been well-documented that social support can be an important aid to medication adherence.

The medication monitoring device can be linked into a wellness monitoring and communication system or it can be implemented as a stand alone system or connected to a variety of other remote health monitoring and security products. In all of these suggested implementations, the data from the medication monitoring device will be made available to authorized remote caregivers through fixed or mobile communication platforms such as Internet browsers on personal computers or mobile phones and PDAs. With many such systems, the caregiver can program medication reminders to be sent to the elder's Home Gateway, and they can set medication usage error thresholds that would trigger email and/or cell phone alerts.

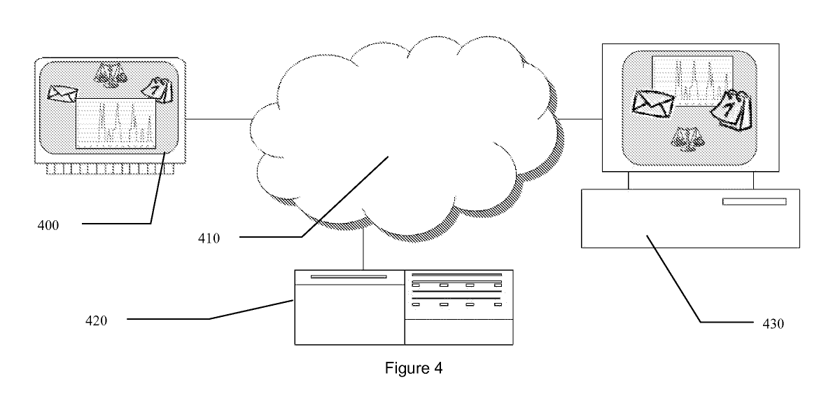

One embodiment of the medication monitoring device can be offered as a stand alone product or integrated with other remote monitoring, communication and medication management products. However, it will ideally complement elder care system for remote wellness monitoring and communication such as that illustrated in FIG. 4. These remote monitoring systems include hardware and software components that collect and send information between an elderly person in their home, using a data collection gateway device such as 400 that is in direct communication with the present invention, a central database 420, and a network of family caregivers at home, at work, and around the community represented by 430. Please note that as mentioned earlier the present invention has the capability to communicate directly with the network of 410. If the only device present at home is the medication monitoring device then it will take the role of 400.

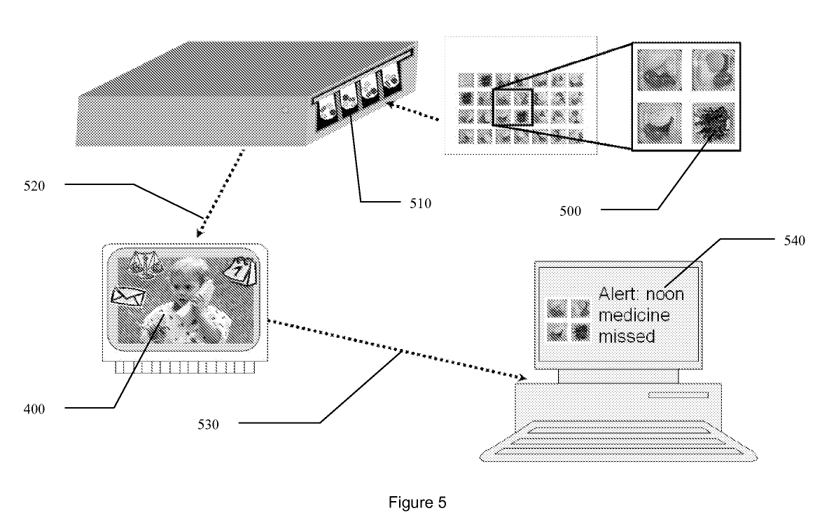

The Home Gateway (HG) 400 of FIG. 5, is a computer with sensor components to monitor wellness and communications technology to receive reminders, send acknowledgements, and exchange messages. In one embodiment of the present invention, a medication monitoring device can send monitoring data to the HG 400 via a wireless connection 520, and the HG 400 can serve as a base station to relay that data to the remote caregiver 540 over the HG's network connection 530. FIG. 5 illustrates the exemplary steps for how one embodiment of this device can function as a component in a remote monitoring and communication system with the remote caregiver. The first step (illustrated in FIG. 5) begins automatically after the person takes their scheduled medications and returns the prepackaged medication card into the preferred embodiment or remote medication monitoring device (RMMD) where it is stored 510. When completely inserted, the prepackaged medication card will click into place and turn on the power. Then the RMMD will automatically scan the medication card to create a clear digital picture of the remaining pills in the transparent plastic compartments as illustrated in exploded view 500. Next, RMMD software will process this image to determine which pill compartments are full, empty, or partially empty. The software will then create a medication usage record with the following components: the scanning date and time, the full digital picture (perhaps using jpeg compression) of the medication package, and the auto-detected status of each compartment. Because the medication usage record includes a full picture of the medication package, the caregiver can visually examine any pill compartments that the auto-detection algorithm labeled as partially empty. This is not anticipated to be a frequent occurrence. It would only occur if a pill got stuck in the compartment, or if an unusual alignment of pills presented an ambiguous image to the detection algorithm. In either rare event, the capability to remotely observe the contents of the medication package will provide additional information and assurance to the caregiver. In the second key system step 520, the RMMD sends the medication usage record to the elder's base unit or Home Gateway 400 over a wireless (possibly but not limited to Bluetooth) or wired connection. The Home Gateway could be a home computer or a processing unit that is part of a larger remote monitoring system. Wireless transmission to the base unit allows the medication docking station to be stored in a convenient location away from the base unit. In the third key step the elder's home base unit relays the medication usage record to the caregiver first through the network 530 and thence via email, cell phone messaging, or web browser.

Keeping medications away from children may be a priority in a typical home where children live or visit. There are several additional security measures that the RMMD can offer to families who have children in the home. The medications in the blister packs will no longer be visible (tempting to a child) and no pill compartments can be opened when the package is docked in the station. A mechanical locking device can be easily added to the docking station to prevent access to the medication package without a key. Alternatively, an electronic locking mechanism can be added to prevent access without entering a pass code (the electronic locking system can also be activated by the remote caregiver).

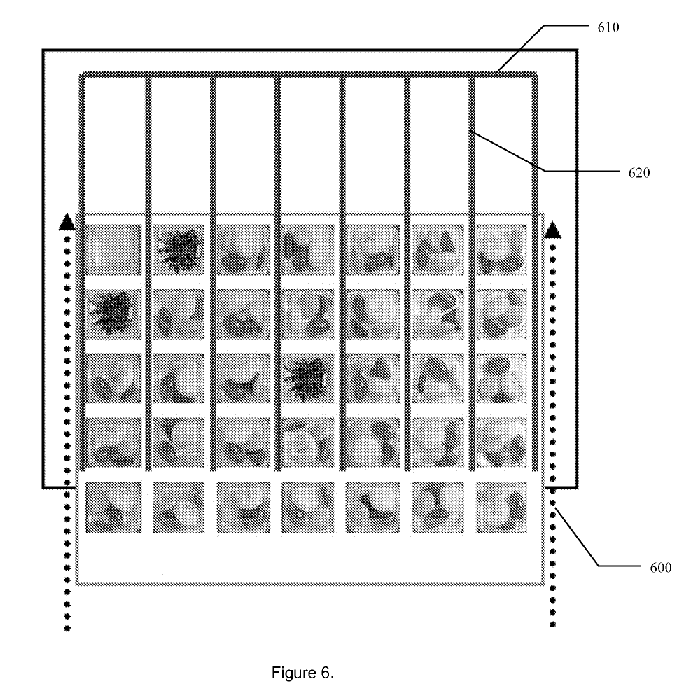

The RMMD, as illustrated in FIG. 6, will include a simple mechanical structure 620 with dividers that slide between the pill compartments to guide the medication package into a consistent and predictable orientation with its transparent pill compartments facing down toward the scanner. The slide glides 620 will separate the pill compartments as the medication package is inserted, and they will reinforce a predictable orientation. The medication package (with the pill compartments hanging down toward the scanner) will rest on the scanner glass with the two side supports of the mechanical structure forming an outer boundary surrounding the compartments. To ensure a snug fit, the space between the slide-guides will be set to just barely accommodate the width of the medication compartments. This structure will have a keyed opening in the front so that there will be only one way to insert the package. The structure will be closed in the back.

The processing software is triggered to run when the prepackaged medication card it is inserted into the mechanical support structure. It will activate the scanner to capture a digital image of the medication package and store this picture (perhaps as a compressed image) to become part of the medication usage record created for each scan date and time. The software will then process the image to detect which pill compartments have been partially or fully emptied. This algorithm consists of two main steps:

Step 1—Detecting the borders between pill compartments. This is simplified by the mechanical support structure that forces the prepackaged medication card into a tight fit and predictable grid prior to scanning. Therefore, the algorithm just needs to verify that the prepackaged medication card has been inserted properly, and the grids are aligned as expected.

Step 2—Processing images of each pill compartment in the grid to determine whether the compartment has been partially or completely emptied. The detection algorithm is based on expected color distribution of filled compartments and differences from the background (an emptied compartment has very little color information). Not only are the pills missing, breaking the foil backing exposes the housing background that will be selected to be in high contrast to the compartments. The software algorithm optimizes detection probabilities by updating expected color distribution statistics each time the medication card is re-inserted.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A dispensing and monitoring device for dispensing articles from an article package, the article package comprising an array of article retention areas, each article retention area being operable to hold at least one article therein, one side of said article package providing transparent covering over the article retention areas, said device comprising:
a housing for receiving said article package, said housing being secure and child resistant;
a pre-calibrated digital scanning element within the device, the scanning element being operable to digitally scan the transparent covering of the article retention areas and digitally process the scan to determine what articles have been removed from which article retention areas.

2. The dispensing and monitoring device of claim 1, wherein the housing is adapted to accept article packages only if inserted with a particular orientation.

3. The dispensing and monitoring device of claim 1, wherein the housing is adapted to accept article array packages in the form of a card with blister packaged medication and inserted in a particular orientation.

4. The dispensing and monitoring device of claim 1, wherein the housing is adapted to accept article array packages in the form of a compartmentalized plastic tray with one side covered with an easily penetrable material and the other side covered with a transparent plastic.

5. The dispensing and monitoring device of claim 1, wherein the digital scanner is operable to digitally scan the side of the article array package that is covered with transparent plastic and locally process the scanned data.

6. The dispensing and monitoring device of claim 1, wherein the digital scanner is operable to digitally scan the side of the article array package that is covered with transparent plastic and transmit the scanned data to another computer for further processing.

7. The dispensing and monitoring device of claim 1, wherein the housing further comprises a processing unit that executes instructions to process the scanned data and generate a report of the results.

8. The dispensing and monitoring device of claim 1, wherein the processing unit is operative to report the results to a local gateway device.

9. The dispensing and monitoring device of claim 1, wherein the processing unit is operative to report the results to a remote computer via a public access network.

10. The dispensing and monitoring device of claim 1, wherein the housing is child resistant by employing a child-proof locking mechanism.

11. The dispensing and monitoring device of claim 1, wherein the housing is portable.

12. The dispensing and monitoring device of claim 1, further comprising a local visual and audible indicator with a monitor display to provide local status.

13. A method to track and monitor taking of regular medications, the method comprising the steps of:
packaging the medicine in a transparent package in accordance with a prescribed schedule;
storing the package in a predetermined housing except when medicine is being administered;
digitally scan the package to obtain an image;
digitally processing the image of the package to determine the presence and absence of the medications.

14. The method in claim 13, wherein the digital image is broken down to a number of cell areas, and the packaging is divided in a array based on the days of the week and time schedules and the step of digitally processing the image further comprises examining each cell area.

15. The method in claim 14, wherein the step of processing the image further comprises for each cell, measuring the total red, green and blue content of the cell.

16. The method in claim 15, further comprising the step of identifying a cell as not empty if any significant red, green or blue content is measured.
